(19) United States
(12) Patent Application Publication
(10) Pub. No.: US 2009/0248563 A1
(43) Pub. Date: Oct. 1, 2009

(54) METHOD AND APPARATUS FOR ON-LINE AUCTIONS

(76) Inventors: Michael Deasy, Pasadena, CA (US); George Penner, Pasadena, CA (US)

Correspondence Address: MORRISON & FOERSTER LLP, 755 PAGE MILL RD, PALO ALTO, CA, 94304-1018, US

(21) Appl. No.: 12/060,773

(22) Filed: Apr. 1, 2008

(51) Int. Cl. G06Q 30/00

(52) U.S. Cl. 705/37

(57) ABSTRACT

An on-line (Internet or web-based) auction intended for selling real property and other unique items has several features and advantages adopted for such transactions. In one version, a descending price auction is used with the price descending at time intervals in unpredictable increments; the first bidder acquires the property. An unpublished reserve price is set initially by the seller, but he can lower the reserve price during the auction if desired. Typically the seller pays the auction organizer an up-front fee which is a percentage of the property's listing price before the auction. The buyer also pays a percentage of the purchase price to the auction organizer when the property is sold. In another type of auction, the price is incremented at amounts determined by the auction organizer, and amongst several bidders at each successive price level, only one is randomly chosen, the randomly chosen bidder is sold the property when there are no bidders at the next higher price level.

### FIELD OF THE INVENTION

This disclosure relates to computer-enabled auctions and more specifically to such auctions for sale of unique or high cost items such as real property.

### BACKGROUND

The U.S. real estate market as of early 2008 for residential properties is in a descending trend nationwide. Some sellers are looking for alternative options as current inventory increases and as houses for sale languish on the market. Other sellers will have no choice—with 1 million foreclosures anticipated over the next seven years with adjustable rates recalibrating.

This downward pressure (common in cyclical real estate markets, not just at one time in the U.S.) not only creates panic amongst sellers, but also real estate agents. Because many owners remain unrealistic about their properties' price appreciation, agents have a more difficult time pricing properties to sell. Commission-based agents also do not get paid until a property closes escrow—with an agent incurring time, energy and significant marketing expenses upfront.

Auctions are a known option for marketing, generating interest and selling real property. But there is no consistent financial incentive for “realtors” (real estate agents in the U.S. and known by other terms elsewhere) to endorse and embrace the method, independent auction firms to date have been unable to assemble the appropriate platform or alliance to be successful on a larger scale, and unlike fine art auctions, real estate auctions often have the negative connotation of a distressed sale.

### SUMMARY

The present method combines advantages of auctioning real property with the familiar dynamics, process and methodology associated with real estate sales in the U.S. (and elsewhere) by establishing a universal “realtor friendly” online bidding option—that is available to buyers/sellers who have retained a licensed real estate salesperson in one embodiment. Existing auction companies have relied primarily on “For Sale by Owner” (FSBO) participation and have not encouraged agent endorsement or involvement.

The present system, acting as a marketing facilitator in one embodiment, invites sellers, agents and brokerage firms to utilize an auction to sell real property. For the seller, auction sales can generate intense interest rapidly and can consequently generate higher prices. Because sales are generally final, auctions do not encompass lengthy contingency periods. This security benefits the seller and realtor.

Real estate agents may avail certain properties to be auctioned for sale. Preparing the property for auction, an inspection may be conducted by the seller and an appraisal would be completed by a lender. Minimum reserve pricing (if applicable) is set at e.g. 90% of the property's appraised value. All disclosures, photographs, property information as well as competitive and neighborhood data may be posted online (via the world wide web) by the agent for buyer review, prior to their registration. This process allows for all contingencies, except financing, to be removed prior to the auction.

A complete marketing program may be made available for each property—providing agents in one embodiment with an affordable, turn-key integrated advertising solution (“marketing in a box”) through the auction organizer via the property sales fee (see below) to generate awareness and drive qualified consumer traffic to upcoming auctions.

The auction bidding is also computer enabled and takes place in one embodiment computer enabled and online (via the world wide web) at a website operated by the auction organizer where the website is conventionally resident on a server, and accessed by sellers and bidders via a web browser. Registered bidders, who have completed their financing prequalification, log-in to their desired property auction on the auction day and bid against other registered bidders. Various auction methods are possible. For single-property auctions, one method is the presently disclosed descending bidding technique. An alternative allows for properties to be auctioned in an ascending price auction method using an element of chance.

Once bidding is complete and a winner (buyer) is determined, escrow may be opened conventionally and the listing real estate agent may conventionally organize the necessary documentation and finalize financing to complete the real estate sale.

Sales agents (or sellers) in one embodiment are charged a transaction fee by the auction organizer based on the value of the house to be sold—equal in one embodiment to approximately 0.5% of the listing price. This will draw buyers directly to the listing (seller's) agent who thereby stands to receive an additional agent's fee through a dual (buyer-seller) representation. In addition, once the auctioned property has sold, all registered potential buyers become sales leads for the listing (seller's) agent. Additionally, a buyer-premium fee (commission) of, e.g., 1.95% may be charged by the auction organizer to the successful bidder at close of escrow (the actual completion of the sale).

Since in one embodiment the auction organizer is a marketing facilitator and not a real estate brokerage firm, auctions may require sales agent representation on both sides (buyer and seller).

Typically the present auctions are carried out by an Internet website operated by the auction organizer, and accessible via web browser by sellers and potential bidders before, during, and after the auction. Payments may be made to the auction organizer via the website (using credit cards, debit cards, PayPal, etc.) or offline. The actual bidding (auction) platforms are separate software modules that operate as described here and are conventionally linked to the website; coding the website and bidding platforms would be routine in light of this disclosure since on-line auctions are well known in the field of computer science.

In addition to the method, also contemplated are a computer program which carries out the auction and is typically run on a server (computer platform) under control of the auction organizer, a computer readable medium such as a CD, disc drive, or computer memory storing such a program as computer code, and the programmed server computer platform. Coding such a program would be routine in light of this disclosure.

### BRIEF DESCRIPTION OF THE DRAWINGS

FIG. 1 shows a flowchart of pre-auction activity.

FIGS. 2A, 2B shows a flowchart of auction and post-auction activity.

FIG. 3 shows a calendar of the events of FIGS. 1 and 2.

### DETAILED DESCRIPTION

For many types of real and other property (such as yachts, artwork, and other unique items), selling via auction is an alternative to traditional brokerage. While marketing of a property by traditional real estate brokerage firms can take many months, the present auction process takes every aspect of real estate (or other property) marketing and dramatically compresses the sales time, minimizes carrying costs—creating a single moment of competitive bidding that determines the property's true market value.

Auctions are unique events that focus market attention on the property, at the expense of competing properties. Further, auctions create urgency for buyers who wish to purchase the property, and an absolute buying deadline that did not exist prior to offering the property via auction. Auctions also allow for a complete set of disclosures, third-party inspection reports and preliminary financing approvals be made available to the bidders prior to the auction.

In one embodiment, the auction organizer is an entity that provides buyers, sellers and their real estate agents with a method to buy or sell property in a timely fashion and with a greater degree of certainty. Unlike most conventional real estate auction companies that coordinate all the details, in one embodiment the auction organizer need not be a real estate agent. The auction organizer also need not be the primary contact with sellers and bidders. That may remain the responsibility of a real estate agent(s) who already has a trusted relationship with both. The auction organizer acts as the facilitator—providing both the marketing to generate awareness and traffic about a property and the computer enabled auction platform to perform the actual bidding process.

85% of all home buyers in the United States now utilize a real estate agent during their search for a house. There are numerous reasons why consumers are likely to continue to utilize real estate agents: consumer acceptance of agent utilization; strength of client-agent existing relationships; agent in-market grasp, knowledge and experience; client confusion and uncertainty about the process; and consumer need for reassurance—with what is most likely their largest financial decision. Although the Internet has become an important research tool for house buyers, most consider it an information resource rather than a substitute for a real estate agent. The Internet does not replace the need of an agent in most real estate transactions.

Today real estate agents see auction companies as competition. Most real estate auction companies primarily grew from auctioning farm equipment and other mechanical items. They have adopted the philosophy of setting up all internal resources to sell a property. This includes not only the auctioneer, but also the sales, client service and marketing staff. With this structure and inherent overhead in place, the traditional real estate auction company is unable and unwilling to pay a normal commission to a licensed real estate agent. Their primary fee to agents is usually a referral fee, and real estate agents do not willingly accept this payment structure.

The present method in one embodiment allows for a normal sales commission for both the real estate agent and his real estate brokerage firm. Because of its independence, the auction organizer may offer its platform to all real estate brokerage firms—making it available to every real estate agent. This allows the organizer to be “broker neutral” and not limit its usage due to brokerage boundary disputes.

Another option is for the auction organizer to form a partnership with a major media vehicle (such as a newspaper or Internet search engine) to build awareness, available product and acceptance quickly of the auction process.

In one embodiment, the auction organizer pays ¼ percentage point of the listing price as a “strategic alliance” fee paid to media partners in respective markets. Allocating a transaction fee by market allows alliances with different media partners.

Certain aspects of the traditional auction process are standardized in accordance with this disclosure. No facet of any auction is more difficult than the seller determining the minimum bid/reserve price. (The term “seller” or “buyer” here generally also refers to acts undertaken by the seller's agent or buyer's agent within the terms of the agency.) Traditional auction houses handle this on an individual basis, working with listing real estate agents and sellers to determine reserve pricing based on similar sales, market conditions, seller tendencies, and sales goals. In one embodiment the auction organizer standardizes this process by setting the reserve price at, e.g., 90% of the property appraised value. (This is e.g. the result of a professional appraisal, obtained in advance by the seller.)

In the present online (web-based) auction environment, the auction organizer in one embodiment offers two different bidding platforms depending on the type of property being sold. These bidding platforms both differ from conventional auctions.

In the first online (web-based) platform, the auction is a descending price, simultaneous, non-published reserve price auction. With the automatic price reductions, bidders initially see displayed an initial asking price—one that is set somewhat above the seller's anticipated sales price. Slowly, over a period of time (e.g., hours), the price drops in slight, random (unpredictable) increments. The auction ends when the first bidder accepts the current displayed price. The planned duration of the auction is typically not made known to the bidders before or during the auction.

This achieves several key objectives: It somewhat mimics the way the traditional United States real estate market functions today. Descending bidding reduces the possibility of multiple successful bidders. Since the auction takes place online, bidders have no knowledge of how many other people are looking to bid on the property. The first bid wins, so the descending method allows for maximum sales price, and ultimately having a successful auction—even if only one bidder is present. There is no need for the auction organizer to create external excitement in an online environment by placing pressure on multiple people to compete against each other by outbidding one another. This excitement and pressure is placed on the bidders solely by themselves. This creates a “don't miss out” mentality—pushing the bidders to accept a higher price before another bidder steps in and secures the property. It also simplifies setting a reserve price. In the traditional/ascending price auction, excitement and momentum for the auction is generally garnered through low minimum or reserve prices, relative to true value. The prospect of a “deal” generates larger consumer bidding pools. Establishment of the reserve price with sellers is usually the most difficult part of convincing the seller to sell by an auction. With the descending price auction (and more similar to a traditional real estate listing), the seller is guaranteed that the property is first offered at the highest price possible.

Descending bidding also eliminates the “shill”. The largest bidder concern of participating in any auction is the concern of a “shill”—an individual who artificially raises the bid pricing on behalf of the seller. In a descending price auction, use of a shill is impossible. Once one bidder accepts, the active bidding ends. Descending bidding allows for the reserve price to be modified dynamically during the actual auction. An initial reserve price is set established prior to bidding, but need not be revealed to the bidders. During the auction, if the price approaches the minimum, (confidential) price, the seller has the option of lowering the reserve price privately—increasing the chance of eventual sale.

For simultaneous sales of multiple similar properties such as for tract and multi-unit real estate developments, the auction organizer may offer a suitably modified form of the above descending price auction.

In another bidding (auction) process, also conducted via the Internet, an ascending bid technique is used, but with an element of chance introduced in order to allow bidders to feel that they are not overbidding. In this case, an initial price is set by the seller and published and the auction begins and bids accepted at the initial price for a predetermined period (e.g., 20 minutes). Presumably a plurality of bidders make bids at the initial price. One of these bidders is selected by a random process to be the “winning” bidder of the initial bidding round, and so notified.

However, a next round of bidding then begins immediately at a higher price, the price increment being set by the auction organizer. Only if no one bids at this higher price for the predetermined period is the auction terminated, and then the previous round “winning” bidder is sold the property at his bid price. If one person only bids at the higher price in the current, he is sold the property at his bid price.

If a plurality of bidders bid at the higher price, again only one of them is selected randomly to be the “winning” bidder of that round, and the price is incremented again for the next round. The process is repeated with additional rounds until at round price there are no bidders (hence the “winning” bidder at the previous price is sold the property) or only one bidder, who is sold the property. [?OK re only the bidder at the highest price?]

The rules, regulations and practices of transacting of real (and other) property are different throughout the world. However, the Internet is the same and the method of auctions is widely accepted, so the present embodiments are applicable world-wide with suitable local modifications.

The auction organizer may derive revenue from various sources:

1. Auction Transaction Fee: the organizer is paid a transaction fee by the agent (or seller) for each property registered for auction. This transaction fee is based on the listed property value and is for example approximately 0.5% of the listing (asking) price when the property is registered for auction; this need not be the actual initial price at auction. The fee is set upon execution of the auction agreement—and is paid even if the real estate is sold prior, or subsequent to the auction. This may stand as long as the original seller's property listing agreement is in effect. Exemplary such fees are:

| | |
|---|---|
| | Cost of |
| | auction |
| Home Listing Price Range | service |

| | | |
|---|---|---|
| $250,000 | $500,000 | $2,500 |
| $500,000 | $750,000 | $3,750 |
| $750,000 | $1,000,000 | $5,000 |
| $1,000,000 | $1,250,000 | $6,250 |
| $1,250,000 | $1,500,000 | $7,500 |
| $1,500,000 | $1,750,000 | $8,750 |
| $1,750,000 | $2,000,000 | $10,000 |
| $2,000,000 | $2,250,000 | $11,250 |
| $2,250,000 | $2,500,000 | $12,500 |
| $2,500,000 | $2,750,000 | $13,750 |
| $2,750,000 | $3,000,000 | $15,000 |
| $3,000,000 | $5,000,000 | $25,000 |
| $5,000,000 | $10,000,000 | $50,000 |
| $10,000,000 | — | See Agent |

2. Dual-Agent Commission Referral Fee: In 2006, 28% of all realtors represented both buyer and seller in their property transaction. Here, the auction organizer is paid a 0.5 percentage point fee by an agent (based on the listing price) if either a seller or buyer who does not have an agent is successfully referred by the organizer to that agent, thus allowing for additional revenue to the auction organizer in event of such dual representation by an agent.

3. Buyer Premium: It is common practice for auction firms to charge a fee to buyers—in some cases, as much as 10-20% of the sales price. Here the organizer charges a fee of e.g. 1.95% of the actual selling price on all transactions. Although this buyer's fee thereby increases transactional costs to him by 1.95% versus the traditional listing approach, it should not cause a hurdle for bidders. Auctioneers have learned that as long as the buyer's fee is under 2%, buyers do not calculate it into their bid price. It is viewed as a transaction fee rather than an additional cost. This fee provides the auction organizer with funds to develop profitable strategic alliances in markets and, more importantly, it maintains the fee structure of the original commission agreement between seller and agent where the seller pays a percentage of the sales price to the buyer's and seller's real estate agent(s)—keeping agents incentivized to utilize the present method.

4. Financing Referral Fee: Ancillary services provide additional revenue to traditional real estate brokerage firm. As with a mortgage services arm, a financing referral fee usually generates a fee of 0.35%-0.45% of the amount of the loan originated.

5. Advertising Revenue: There will be advertising dollars generated from online revenue from sponsorships, links and banners on the organizer's website.

6. Title/Escrow Commissions: Similar to the financing arrangement, ancillary services can co-manage the title/escrow components.

7. Revenue derived from continuing relationships from financing side on successful and non-successful bidders. This relates to future re-financing.

8. Possible revenue from qualified lead generation/database: Customer lead generation may be another future source of income for the organizer.

In one embodiment all required disclosures relating to each real property to be auctioned, including inspection reports, transfer disclosure statements and property appraisal are completed in advance of the auction and available e.g. in a PDF file posted on the auction organizer's website for review pre-auction by potential bidders. Auctions here are “as-is” sales. Sellers may be required to obtain an approved, third-party property inspection prior to the auction. Even though this is different than a traditional real estate sale (in which buyers pay for their inspection) this provides further support for an “as-is” auction sale and eliminates price renegotiation after the auction is completed. The present method allows agents to properly inform possible buyers of all information before the auction takes place. This will virtually eliminate cancelled transactions after the opening of escrow. Buyers will be required to acknowledge receipt or and accept all needed documents prior to bidding.

The conventional real estate buyer's financing (mortgage loan) contingency may still remain, but buyers may be pre-approved by a preferred or approved lender prior to bidding.

A non-refundable deposit will be paid by the buyer to the auction organizer at completion of each auction. A credit card hold for example at bidder registration allows the organizer to immediately secure a non-refundable deposit from the winning bidder for each property. This method allows the seller to consolidate showings, negotiations and contingencies into one timeline, most likely 21-30 days. This method extends beyond distressed properties, to include sellers looking for tax benefits or looking to sell before expensive carrying costs erode value.

Properties that have a difficult-to-determine market value are excellent candidates for auction. For real properties with a geographically dispersed buying pool, such as property in resorts, a customized marketing program can educate all potential buyers concurrently and convene them for a single auction. For a portfolio of multiple properties, an owner selling a group of properties may wish to sell them all at once using an auction.

In terms of advantages to the bidders, all information and disclosures here are made in advance of bidding. By use of the Internet (web), the present method allows consumers to be provided with all necessary information and details, prior to making a purchase decision. Definiteness of sale is provided—many buyers do not want to prolong the negotiation process when purchasing a property. Once they become emotionally attached to a property, they want to have certainty that they actually can own it. A sense of a possible below-market purchase is provided with any auction. As with any auction, there remains a sense by a bidder of obtaining the property at a fair price—or even at a discounted price. The overall market will set the value.

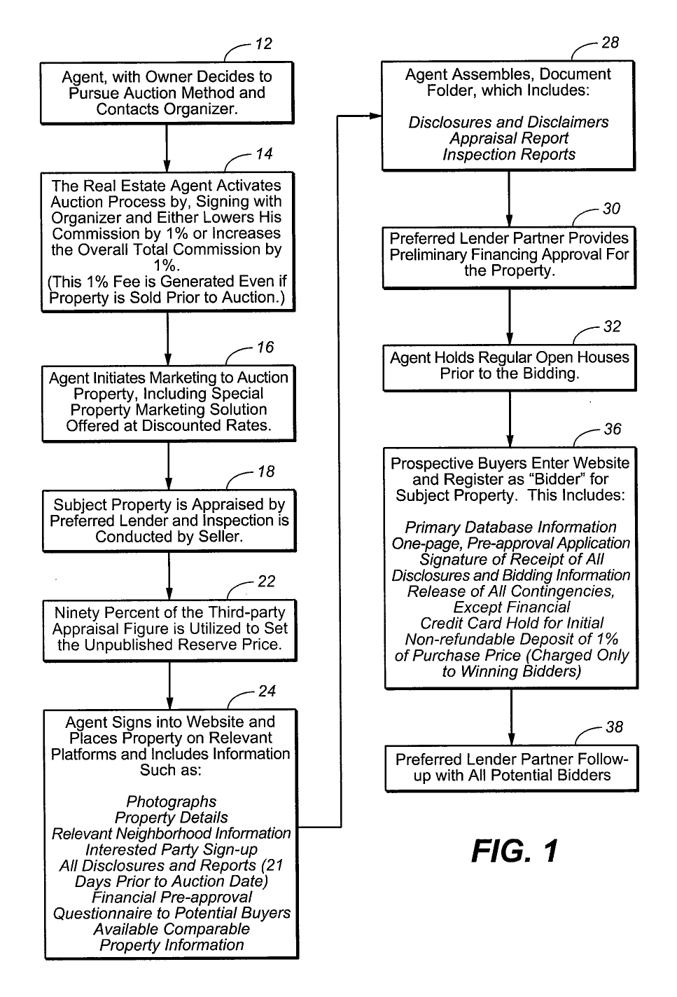

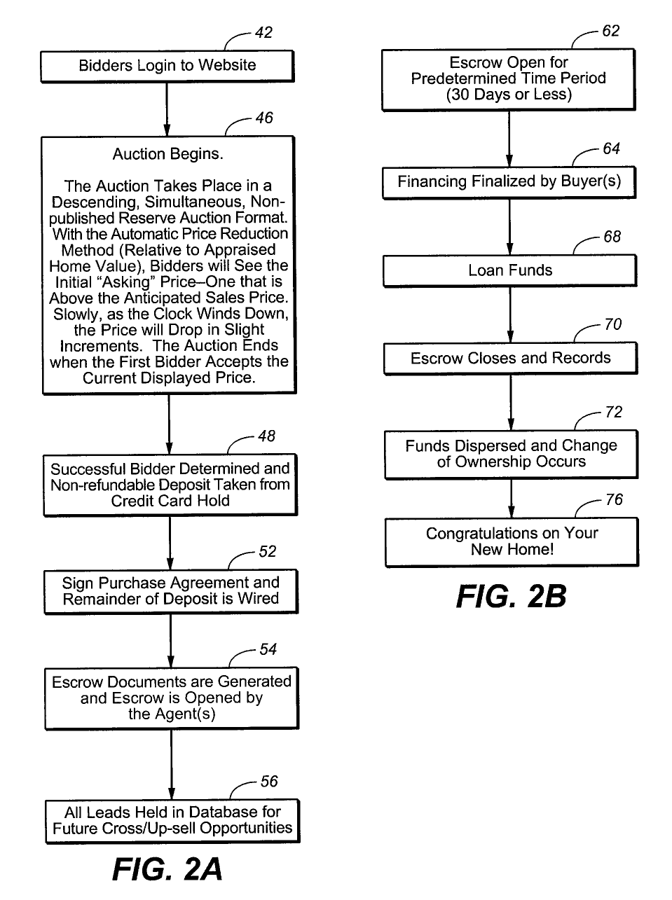

FIG. 1 shows in flowchart form relevant activity prior to the actual auction, in one embodiment. It is to be understood that this shows a combination of actions by individuals and corresponding actions that are computer enabled by the website operated by the auction organizer that conducts the pre-auction, auction and post-auction activity. (FIGS. 2A and 2B show respectively activity during and post-auction.) In FIG. 1 at step 12, initially the selling agent, who already has been conventionally retained by the property owner (seller), decides (with approval of the owner) to pursue the auction method and contacts the auction organizer. This may be by email or in person or most likely by accessing via a web browser the website operated by the auction organizer, which has a corresponding user interface accessible by the agent acting on behalf of the property owner. At step 14, as indicated the real estate agent (or seller, if not represented) starts the pre-auction process by executing an agreement with the auction organizer, typically via the website. The real estate agent has the option of altering his commission by absorbing the seller's fee paid for the auction transaction or passing the cost on to his owner. Note that this auction fee which as indicated here is 1%, but otherwise may be for instance ½ percent as indicated above, is paid even if the property is sold through other means, that is other than by the auction. This fee is paid to the auction organizer. It is typically a percentage of the registered listing price of the property as disclosed above.

Next in step 16, the agent initiates conventional or other pre-auction marketing of the property, including using if desired a property marking program offered by the auction organizer at discounted rates involving advertising on the auction website and elsewhere. Of course this is optional with the owner and/or agent. Next in step 18, the property is appraised (by a potential mortgage lender usually) and a property inspection is conducted by the seller. The appraisal determines the value of the property and the inspection determines its condition. Next in step 22, in one embodiment the (unpublished) auction reserve price is set at 90% of the appraised value. Of course the reserve price may be set by other means in other embodiments, but this is believed to be convenient and fair. Next the agent signs into the auction organizer website via his web browser and enters the property details, including all information and disclosures relevant to the property. These are the typical types of information made available to describe properties on sale, such as for residential real properties in the United States. Of course local practice may vary and other types of information may be provided.

Next at step 28, the agent assembles a document folder, which is a set of PDF documents which includes as shown the relevant documents made available to the potential lender. The lender is typically a bank, mortgage broker, etc. which provides preliminary financing approval for the property. Note that in this case the lender has been brought in by the seller's agent since no buyers are yet involved. (Of course there is no requirement for the buyer to actually borrow from this lender later.) Next in step 32, the agent as is conventional holds an “open house” prior to the bidding so that perspective buyers, if they wish, can visit the property, as conventional in real estate sales.

Next in step 36, some time prior to the auction the property details and the related information are posted for viewing by the public on the auction organizer website. Perspective buyers may access the website and register as a bidder for the property for a future auction with a date already determined for the auction. At this point, the perspective bidders each provide the information indicated via the user interface to the website, including their personal data, a pre-approval application for financing, if needed, and an indication of his signature for receipt of all the required disclosures. Also provided is a release of contingencies, except financial contingencies, as in typical real estate transactions. Also the perspective bidder provides, e.g., a credit card “hold” on his credit card for an initial non-refundable deposit of e.g. 1% or ½ percent of the purchase price or a fixed amount such as $5,000, which later is actually charged only to the winning bidder. (It is typical in U.S. real estate sales that such a non-refundable deposit is made at the time that the buyer's offer is accepted.) Next at step 38, the lender follows up with the potential bidders to see if they are interested in using the lender as the financing party. This is typically conducted via for instance email or by other communication means.

FIG. 2B shows the activity during the actual auction, which typically takes place over, for instance, a matter of several hours. The maximum duration of the auction is set by the auction organizer and may vary from minutes to days; a typical maximum duration is 3 hours. In any case, on the day of the auction the bidders log on to the website via the Internet from their personal computers using their web browser to access the website bidder interface at step 42. Next at 46, the actual auction begins at a predetermined time. As indicated, this is a descending simultaneous bid non-published reserve auction. The bidders initially see displayed on their web browser the initial asking price, which is typically set by the seller at or somewhat above the anticipated sales price. This price is set by the seller. As the auction winds down, the price drops in small but unpredictable decrements at similarly unpredictable time intervals. As the price goes down, the time intervals may lengthen non-randomly under control of the organizer. The time increments and amount of the price decrements are typically each determined by a random or pseudo random process based on, for instance, for the price decrements so many thousands of dollars or some percentage of the sales price and for the time increments, 1 to 30 minutes. The element of randomness in the time increments and price decrements is to cause greater excitement amongst bidders as well as greater uncertainty. When the first bidder accepts the currently displayed price, the auction ends at step 46.

Next at 48, the successful bidder is determined and automatically the non-refundable deposit of e.g. $5,000 indicated at step 36 is charged against, e.g., his pre-registered credit card account. Next at 52, the buyer signs the conventional purchase agreement for instance using an online document (or perhaps offline) and must in a short time (such as 48 hours) pay the remainder of the required deposit of e.g. 3% of the purchase price. This remainder of the deposit may be refundable on a contingency basis such as failure of the buyer to obtain financing. This remainder amount, typically more than would be covered by a credit card, would typically be sent by wire transfer or check to the escrow agent. Next at 54, as is conventional in real estate sales, the escrow documents are generated and escrow is opened by the buying and selling agents. At 56 leads, that is the identity of the bidders, are held in a database for future selling opportunities. This of course would be especially of interest to losing bidders who at this point would not have a property and hence these sales leads are valuable to realtors.

FIG. 2B shows the post-auction activity, as is routine in the real estate field and may or may not involve the auction organizer and may or may not be computer enabled. As shown, this typically involves the opening of the escrow at 62 followed by the financing being finalized at 64 and the loan funds being advanced to the escrow agent at 68. At 70 the escrow closes and the sale is recorded. At 72 the funds are dispersed by the escrow agent and the actual change of ownership occurs. At 76 of course the entire transaction is completed. Hence FIG. 2B shows activity typically not conducted through by the auction organizer or on his website. The funds due by the buyer upon closing include the auction organizer's 1.95% buyers' fee as set forth above, less the $5,000 earlier paid as a deposit.

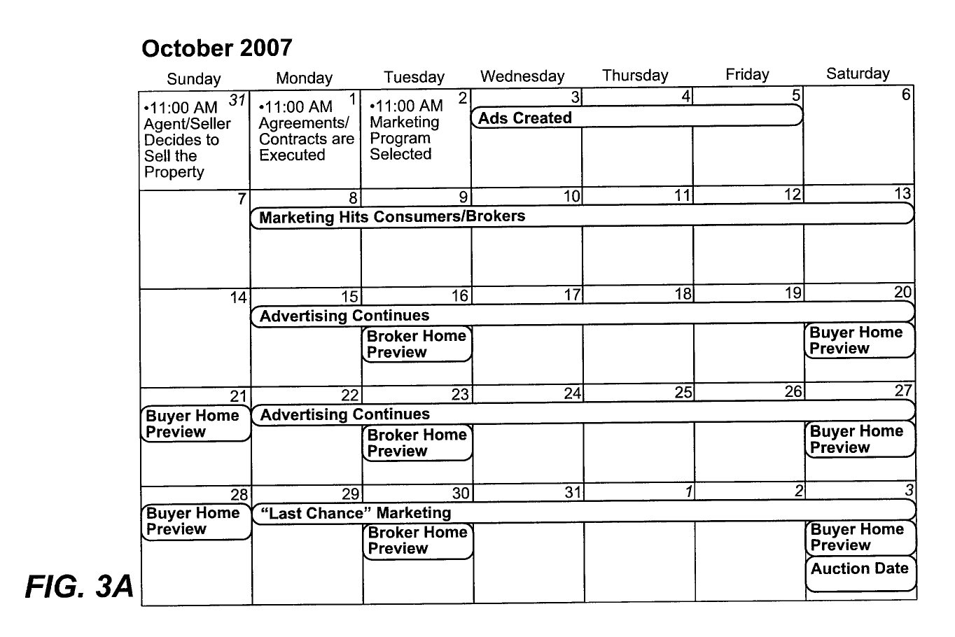

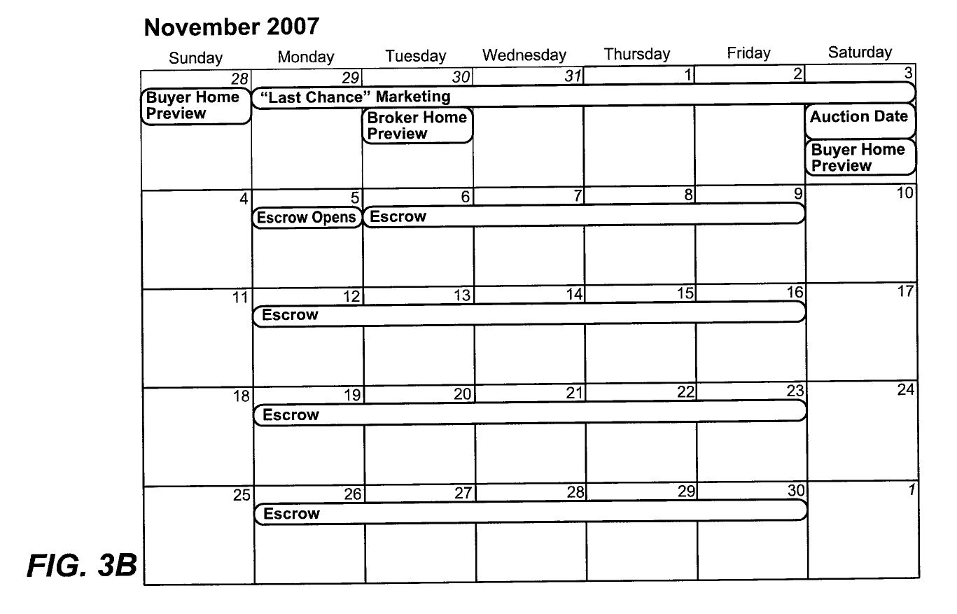

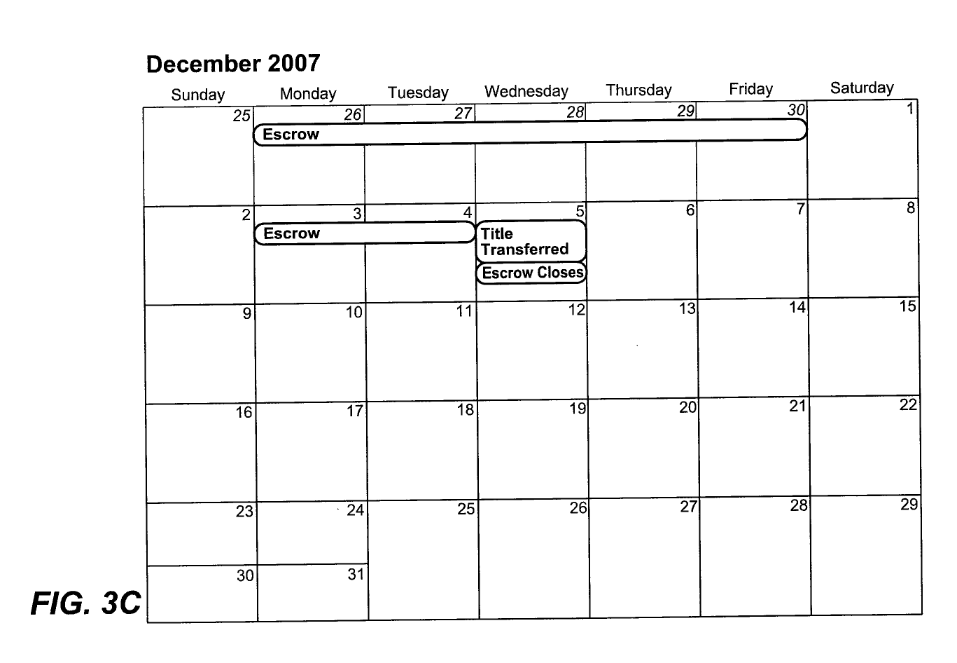

FIG. 3 shows for purpose of illustration a typical calendar of events of FIGS. 1, 2A and 2B, to illustrate the total time required. Of course this is merely illustrative and most of the activities shown in the calendar are routine in conventional real estate transactions.

This disclosure is illustrative but not limiting; further modifications and embodiments will be apparent to those of skill in the art in light of this disclosure, and are intended to fall within the scope of the appended claims.

1. A computer enabled method for auctioning a property, comprising the acts of:
setting an initial selling price and a lower reserve price;
allowing a plurality of bidders to access the initial selling price via a computer network;
beginning the auction at a predetermined time;
decrementing the selling price at time intervals from the initial selling price, the amount of each decrement being random, and each new selling price being accessible by the bidders;
accepting bids via the computer network from the bidders during the auction at the current selling price; and
resetting the reserve price during the auction.

2. The method of claim 1, further comprising the act of requiring the seller to pay prior to the auction an auction fee that is a function of the initial selling price to an organizer of the auction.

3. The method of claim 1, further requiring a successful bidder to pay an auction fee that is a function of the actual sales price to an organizer of the auction.

4. The method of claim 1, wherein the property is real property, and requiring that the seller or buyer be represented by a real estate agent who is other than an organizer of the auction.

5. The method of claim 1, wherein the reserve price is initially set at a predetermined proportion of an appraised value of the property and the reserve price is not accessible by the bidders.

6. A computer readable medium storing code for carrying out the method of claim 1.

7. A computer system programmed for carrying out the method of claim 1.

8. A computer enabled method for auctioning a property, comprising the acts of:
setting an initial selling price;
allowing a plurality of bidders to access the initial selling price via a computer network;
accepting bids from the bidders submitted via the computer network at the initial price, and if a plurality of bidders bid at the initial price, randomly selecting one of the plurality of bidders as the winning bidder;
incrementing the price to a higher price and accepting bids at the higher price;
if a plurality of bidders bid at the higher price, selecting one of the plurality of those bidders as the winning bidder; and
repeating the act of incrementing the price until no bids or only one bid are submitted at a current price, whereupon the bid is accepted from the latest winning bidder or the submitter of the only one bid.

9. A computer readable medium storing code for carrying out the method of claim 8.

10. A computer system programmed for carrying out the method of claim 8.
